(19) United States
(12) Patent Application Publication
(10) Pub. No.: US 2015/0047763 A1
(43) Pub. Date: Feb. 19, 2015

(54) WET AND SNOW TRACTION DESIGN FOR A TIRE TREAD AND SOLUTION FOR PULL UNDER TORQUE THEREFOR

(71) Applicants: Ronald Hobart Thompson, Greenville, SC (US); Olivier Piffard, Mauldin, SC (US)

(72) Inventors: Ronald Hobart Thompson, Greenville, SC (US); Olivier Piffard, Mauldin, SC (US)

(21) Appl. No.: 14/387,592

(22) PCT Filed: Mar. 27, 2012
(86) PCT No.: PCT/US12/30667

§ 371 Date: Sep. 24, 2014

(51) Int. Cl. B60C 11/03; B60C 11/13; B60C 11/12

(52) U.S. Cl. CPC B60C 11/03; B60C 11/033; B60C 11/1236; B60C 11/1307; B60C 2011/0372; B60C 2011/0365
USPC 152/209.18

(57) ABSTRACT

A design for a high-speed tire tread is provided that gives improved performance in both water and snow conditions. The tread region of the tire uses transversely-oriented grooves that each extend across the width of the tread region. There are no grooves or other tread features that provide substantial fluid communication between the transversely-oriented grooves. Features are also provided that decrease the pull under torque associated with such a design.

### FIELD OF THE INVENTION

The present invention relates to a novel design for a high speed tire tread that provides improved performance in both water and snow conditions using transversely-oriented grooves that each extend across the width of the tread region without grooves or other features that provide substantial fluid communication between such transversely-oriented grooves, and more specifically, to such a design with features that decrease the pull under torque associated with such a design.

### BACKGROUND OF THE INVENTION

Road surfaces covered by rain or snow provide challenges to tire designers. Rain on a road surface can lead to a vehicle experiencing hydroplaning particularly at higher speeds. In general, hydroplaning occurs when the tire begins to push water in front of the tire as it travels down the road surface. When the pressure of the water pushing back against the tire is sufficient to lift the tire off the road, hydroplaning can occur and potentially lead to vehicle control problems. The pressure of the water is related to the depth of the water on the road surface and the speed of the tire relative to the road surface.

Put into other words, at highway speeds, standing water in the road produces a hydrodynamic pressure ahead of a rolling tire. As speed increases, this pressure increases. Accordingly, for a given tire at a given pressure, the contact area of the tire on the road progressively decreases, until a significant fraction of the tire is actually supported via a film of water. At this point the tire is said to be “hydroplaning.” Control of the vehicle becomes quite difficult, as the tire can no longer transmit cornering or braking forces.

Tire designers have developed various features to combat hydroplaning. For example, conventionally grooves have been added to the tread pattern that extend along the circumferential direction around the tire to channel the water and prevent pressure build-up in front of the tire. Transverse grooves connected by these circumferential grooves may also be used to assist in evacuating water away from the front of the tire to the shoulders of the tire. For pneumatic tires, the inflation pressure and the tread design tends to govern hydroplaning speed. Those skilled in the art know that hydroplaning speed increases with the increasing inflation pressure. However, increasing inflation pressure is a compromise, as ride quality can be degraded. Those skilled in the art also know that increasing tread pattern void volume can also improve hydroplaning performance. Yet, increasing void volume decreases dry traction and wear, and so is a compromise also.

Snow on a road surface can also lead to a loss of traction particularly at higher speeds. Generally, snow can lead to a loss of friction or grip resulting in the tire sliding across the surface of the snow rather than rolling with traction. Various features have been developed to improve snow traction such as providing studs in the tread region and providing edges extending in the transverse direction in an effort to improve grip.

Efforts have also been made to provide tires for all season use that are capable of acceptable performance on dry, wet, and snow-covered surfaces. However, for high speed use in “on-road” conditions, conventional designs have resulted in trade-offs between rain and snow performance. By way of example, the addition of circumferentially-oriented grooves can improve traction on water covered surfaces (i.e. wet traction) but is deleterious to snow traction. Conversely, the addition of transversely-oriented grooves can improve snow traction but degrades wet traction in the absence of the circumferentially-oriented grooves. Thus, for high speed or “on-road” conditions, designers have typically had to compromise between wet and snow traction.

One solution to these performance compromises is disclosed in published patent application no. WO 2012002947 (A1), which is commonly owned by the assignee of the present application. It shows the use of transversely-oriented grooves that each extends across the width of the tread region without grooves or other features that provide substantial fluid communication between such transversely-oriented grooves. In one embodiment of that reference, which is shown herein in FIG. 1, these transversely-oriented grooves extend in a general s-shaped configuration. In yet another embodiment of that reference, which is shown herein in FIG. 2, these transversely-oriented grooves extend in a general chevron shaped pattern.

A problem now known with first embodiment is that when a tire using these shaped grooves is subjected to a torque, the tread will tend to pull in a direction that is perpendicular to the path that the angled portion of the slant grooves extend. This would be in the upward leftward direction or downward right direction as shown in FIG. 1 depending on the rolling direction of the tire. This is a result of the edges of the grooves which extend in a predominately angled fashion. A problem with the embodiment shown in FIG. 2 is that while its force vectors are balanced out when it is subjected to torque, yielding no pull under torque issues, it is a directional pattern which requires additional care when mounting the tires on a vehicle to make sure that all tires are mounted in the same configuration, thereby preventing uneven wear and other problems among these tires. As a result, neither of these embodiments is ideal for use in the field.

Accordingly, there is a need for a tire having a tread pattern designed for high speed, on-road use having improved performance on both snow and water covered road surfaces, and that has features for reducing the amount of pull under torque when the tire has torque exerted on it. More specifically, a tire having tread pattern that can provide improved performance in both rain and snow without having a directional tread pattern would be very useful.

### SUMMARY OF THE INVENTION

Aspects and advantages of the invention will be set forth in part in the following description, or may be obvious from the description, or may be learned through practice of the invention.

In one exemplary embodiment, a tire for high speed, on-road use is provided having improved wet and snow traction. The tire defines transverse and circumferential directions and has a shoulder positioned along each side of the tire. The tire includes a tread region positioned between the shoulders of the tire. The tread region includes a plurality of transversely-oriented grooves extending between the shoulders of the tire and across the tread region. In some cases, the plurality of transversely-oriented grooves may not be connected by a groove or other feature that would provide fluid communication between the transversely-oriented grooves. These grooves have a portion that is slanted with respect to the circumferential direction and define ribs that have H and B dimensions associated therewith, wherein the ratio of H/B has a value of 1 or less. In some cases, the CSR would be at least 0.7 or higher. In yet other cases, the edges along the grooves have at least a 1 mm (0.03937 inch)×1 mm (0.03937 inch) chamfer on them.

Each of these transversely-oriented grooves can include the following portions. First, a central portion can be provided at an overall angle in the range of about 30 degrees to about 50 degrees from the circumferential direction. Next, a pair of transition portions can be provided. Each transition portion is positioned in fluid communication with the central portion and is connected to the ends of the central portion. A pair of shoulder portions can also be provided. Each such shoulder portion is positioned in fluid communication with the central and transition portions. The shoulder portion is connected to outer ends of the transition portions and is located at least partly along the shoulders of the tire. One or all of the central, transition, and shoulder portions may be linear in shape.

In certain embodiments, the tire may also include a plurality of sipes extending between the plurality of transversely-oriented grooves. The sipes can also include a cavity for receipt of water or snow during operation of the tire.

In a particular embodiment, preferably the shoulder portions are oriented at angle in the range of about 75 degrees to about 90 degrees from the circumferential direction. Other angles may also be used. For example, the shoulder portions may also be oriented at angle in the range of about 80 degrees to about 90 degrees from the circumferential direction.

The central portion preferably includes a groove width in the range of about 3 mm (about 0.1181 inch) to about 5 mm (about 0.1969 inch). Other widths may also be used to provide different embodiments.

A variety of shapes for the transversely-oriented grooves may be used to provide tread patterns of differing appearance. For example, in one exemplary embodiment, the plurality of transversely-oriented grooves may have a generally s-shaped appearance. The tread may further comprise one or more sipes that run parallel to a direction in which a portion of one of the grooves extends.

Variances in the width of the transversely-oriented grooves may also be utilized in one or more of the central, transition, and shoulder portions. For example, the groove width of the transition portions can be shaped to increase in a direction moving away from the central portion towards the shoulder of the tire. Additionally, the groove width of the shoulder portions can be increased in a direction moving away from the central portion towards the shoulder of the tire. Other variances may also be used.

In order to provide additional traction performance improvements, additional features may also be used with the tire. For example, the tread region may be constructed from a flexible rubber composition so as to improve snow traction. The tread region can also include a plurality of voids extending between the plurality of transversely-oriented grooves and providing fluid communication therebetween, and the density of such sipes along the circumferential direction can be increased so as to improve snow traction. Also, the tread could comprise an edge along each groove has at least a 1 mm (0.03937 inch)×1 mm (0.03937 inch) chamfer thereon.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates an exemplary tread region according to the prior art that includes a representative, transversely-oriented groove with sipes according to an exemplary embodiment of the present invention. FIG. 1 is provided as a front view of a portion of the tread region of a tire. For purposes of clarity, only a single transversely-oriented groove is illustrated, it being understood that a plurality of such grooves is repeated along the circumferential direction C of the tire.

FIG. 2 illustrates a perspective view of another example of a tread region according to the prior art with transversely-oriented grooves and sipes according to another exemplary embodiment of the present invention.

FIGS. 3A-3D illustrates a schematic view of changes to a tread pattern of the prior art as described more fully below.

FIG. 4 is a depiction of a FEA model for a portion of a tread that has transversely oriented slanted grooves.

FIG. 4A is an enlarged view of the FEA model of FIG. 4 showing the modeling of the belts, subtread and carcass more clearly.

FIG. 5 shows the deflection experienced by the FEA model of FIG. 4 when an uniform pressure is exerted on it.

FIG. 6 is an FEA model that has no voids connecting between the transversely oriented slant grooves.

FIG. 7 is an FEA model that has voids connecting between the transversely oriented slant grooves.

FIGS. 8A-8D show the footprints of various tread patterns having differing amounts of laterally oriented and circumferentially oriented voids.

FIGS. 9 and 10 are photographs of different tread patterns passing through water, depicting the turbulence created as the tire passes through the water and the amount of surface contact.

FIG. 11 shows a finite element of a rib having H and B dimensions.

FIG. 12 is a graph showing the prediction of pull under torque coupling for different configurations having different H/B ratios and rib inclination angle θ.

FIG. 13 shows a tread design having circumferentially oriented voids that extend between s-shaped grooves.

FIG. 14 shows a tread design having s-shaped grooves and no circumferential voids.

### DETAILED DESCRIPTION OF THE INVENTION

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

As used herein, the following definitions apply.

“High speed” and/or “on-road” use means non-off road use at speeds that can include up to 60 kilometers per hour (about 37 miles/hour) or more.

“Sipe” is used to refer to groove features in the tread that are 2 mm (0.07874 inch) or less in width. During operation of the tire, a sipe in the contact patch is deformed and the sipe becomes either constricted or closed such that the movement of water through the sipe is insubstantial or even prevented.

“Groove” is used to refer to groove features in the tread that are greater than 2 mm (0.07874 inch) in width. During operation of the tire, a groove in the contact patch will still provide substantially for the movement of water through the groove despite any groove deformation that may occur.

“Transverse” or “lateral” refers to the directions parallel to the axis of rotation of the tire and is designated with arrows T in some of the FIGS.

“Circumferential” refers to the circular direction defined by a radius of fixed length as it is rotated about the axis of rotation of the tire and is designated with arrows C in some of the FIGS.

“Z” direction refers to the radial direction of the tire which is generally perpendicular to the transverse and circumferential directions and is designated with arrow Z in some of the FIGS.

“Contact Surface Ratio” or “CSR” is used to refer to the ratio of the tread contact surface area to the total area of the contact patch.

As set forth above, tire designers have previously faced trade-offs between snow traction and wet traction (e.g., non-hydroplaning performance) in creating a tire tread. The addition of circumferentially-oriented grooves in order to improve wet traction unfortunately reduces snow traction. The addition of transversely-oriented grooves improves snow traction but a reduction in wet traction is experienced if circumferentially-oriented grooves are also applied. Among other aspects, the present invention provides a tire having a novel tread that provides improved wet and snow traction without the addition of grooves or other features connecting the transversely-oriented grooves so as to provide fluid communication between the transversely-oriented grooves. It also provides features that reduce the amount of pull under torque of such a design, which is not directional in nature.

### Various Configurations for Transversly Oriented Grooves

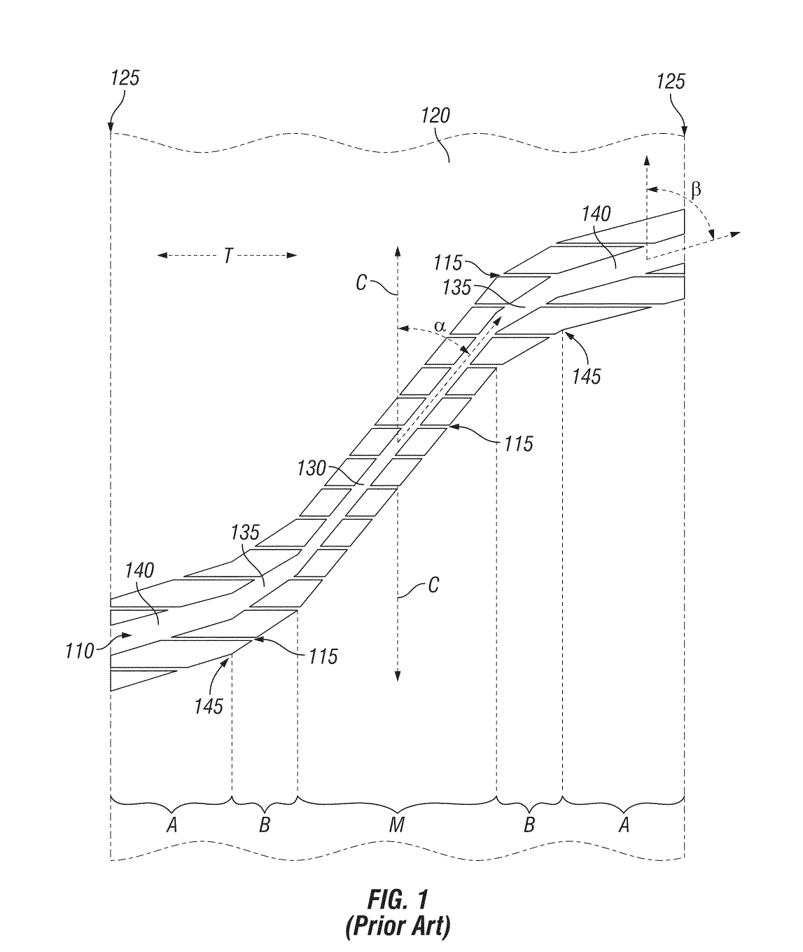

FIG. 1 represents a groove 110 with sipes 115 according to an exemplary embodiment of the present invention without regard to features that reduce the pull under torque problem heretofore described. Groove 110 is oriented along the transverse direction of the tire as represented by arrows T. Groove 110 is located within the tread region 120 of a tire. Tread region 120 is positioned between the shoulders 125 of the tire. It should be understood that tread region 120 would comprise a plurality of transversely-oriented grooves 110 with sipes 115, and this plurality would be positioned along the circumferential directions C (indicated by arrows C). For the sake of clarity in the figures, only one such exemplary groove 110 is shown.

Transversely-oriented groove 110 includes a beneficial construction for improved wet and snow traction. More specifically, for the exemplary embodiment shown, groove 110 can be divided into three portions represented by brackets A, B, and M and referred to as central portion 130, transition portions 135, and shoulder portions 140. These portions are connected and are in fluid communication with each other as will be described.

Central portion 130 is positioned along the middle M of tread region 120 of the tire at an overall angle α from circumferential direction C. Angle α should be in the range of about 15 degrees to about 50 degrees from circumferential direction C. Tread regions with different angles α will be further discussed below. Additionally, preferably the width of groove 110 in central portion 130 is in the range of about 3 mm (about 0.1181 inch) to about 5 mm (about 0.1969 inch). Central portion 130 is depicted as linear in shape. However, other shapes such as wavy or undulating may be used as well. In such case, overall angle α refers to the overall direction or sweep of the groove relative to the circumferential direction C.

A pair of transition portions 135 are positioned about central portion 130 as indicated by brackets B. Each transition portion 135 is located along one side of central portion 130 and is connected to the ends of central portion 130. As such, transition portions 135 are in fluid communication with central portion 130 in that e.g., water encountered along a road surface can travel between central portion 130 and transition portions 135. For the exemplary embodiment of FIG. 1, the width of each transition portion 135 increases in a direction moving away from the central portion 130 and towards the shoulder 125 of the tire. In addition to what is shown in FIG. 1, other overall shapes and widths for transition portion 135 may be used as well.

A pair of shoulder portions 140 are positioned on the outer ends 145 of transition portions 135. More specifically, each shoulder portion 140 is located at least partly about a shoulder 125 of the tire and in tread region 120. Shoulder portions 140 are connected to transition portion 135 at outer end 145 and are in fluid communication with transition portion 135 and central portion 130. As such, water encountered along a road surface can travel between central portion 130, transition portions 135, and shoulder portions 140 and even exit tread region 120 in such manner.

Shoulder portion 140 of transversely-oriented groove 110 is positioned along the shoulder portion A of tread region 120 at an overall angle β from circumferential direction C. Angle β should be in the range of about 75 degrees to about 90 degrees from circumferential direction C. In addition, for the exemplary embodiment of FIG. 1, the width of each shoulder portion 140 increases in a direction moving away from the central portion 130 and towards the shoulder 125 of the tire. Shoulder portion 140 may include other shapes and widths different from that shown in FIG. 1. In such case, overall angle β refers to the overall direction or sweep of the groove of portion 140 relative to the circumferential direction C.

For the exemplary embodiment of FIG. 1, each portion 130, 135, and 140 of groove 110 is equipped with multiple sipes 115. As shown, sipes 115 are linear and oriented along the transverse direction T; other orientations and shapes may be used as well. Sipes 115 provide additional grip for traction, but do not create additional paths for the ingress and egress of fluid from a groove 110. Accordingly, sipes 115 do not allow for fluid communication between grooves 110. The density of sipes 115 along circumferential directions C can be increased in order to improve snow traction. Additionally, if desired, sipes 115 can also be provided with a cavity (not shown) for the receipt of snow or water during operation. It will also be understood that the selection of tread rubber used to construct tread region 120 can be adjusted to improve snow traction. For example, a more flexible rubber composition can be selected for the construction of tread region 120 in order to improve snow traction.

Notably, while a plurality of grooves 110 will be spaced through tread region 120 along circumferential direction C, grooves 110 are not connected to each other. More particularly, no groove or other feature is provided that would connect an individual groove 110 with another groove 110 so as to provide substantial fluid communication therebetween. Unlike many conventional tires, for example, there is no circumferentially-oriented groove or other tread feature in tread region 120 that connects groove 110 with another adjacent groove 110. Accordingly, fluid movement in groove 110 must be between portions 130, 135, and 140 and substantial fluid movement between adjacent groove 110 does not occur. For at least this reason, groove 110 provides improved wet and snow traction without the degradation of snow traction that would occur in the presence of a groove oriented along circumferential direction C.

As shown in FIG. 1, groove 110 overall has a generally s-shaped appearance and provides a tire having a non-directional tread pattern. However, it will be understood by one of skill in the art using the teachings disclosed herein that groove 110 can be used to create other pattern shapes. For example, referring now to FIG. 2 where similar reference numerals are used to indicate similar features, a tire with tread region 220 is depicted have a plurality of grooves 210 and sipes 215. As with groove 110, each groove 210 has a central portion 230, transition portion 235, and a shoulder portion 240 located along shoulder 225. However, grooves 210 create a generally chevron-shaped appearance and provide a tire has a directional tread pattern. It should be noted that the embodiment illustrated in FIG. 2 may be created by minoring one half of the pattern shown in FIG. 1 about the mid-plane of the tire. However, as stated previously, this design has the drawback of being directional in nature.

Again, other patterns can be created using different embodiments of the transversely-oriented grooves of the present invention that need a solution for the pull under torque, which they are proned to have in use. By way of further example, groove 110 could be constructed with a central portion 130 extending across the entire width of the tread region 120 and without transition portions 135 or shoulder portions 140. Non-linear shapes for central portion 130 may also be used provided the grooves 110 are not connected in a manner that allows for substantial flow of water (i.e. fluid communication) therebetween.

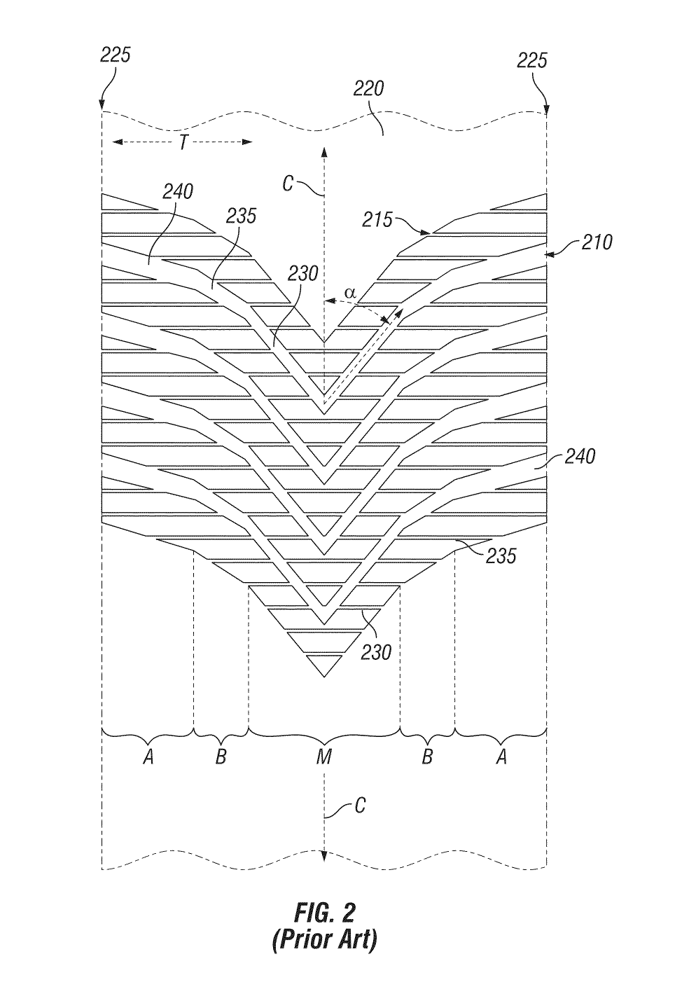

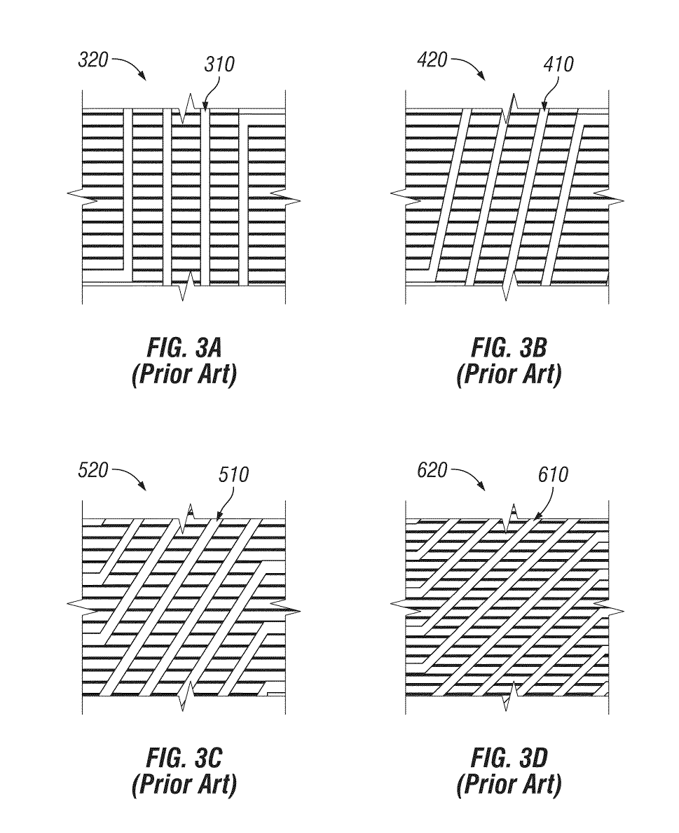

In order to ascertain the efficacy of certain aspects of the present invention, tread studies were performed with testing for wet and snow traction. FIGS. 3A through 3D schematically represent the tread regions 320, 420, 520, and 620 of tires that were tested. A tire size of 245/45R17 was used for the study. As shown in FIGS. 3A through 3D, each tread region has a plurality of transversely-oriented grooves 310, 410, 510, and 610 extending across the respective tread regions. Notably, tread region 320 represents a 0 degree (i.e. completely circumferential) orientation for groove 310. Tread region 420 represents 12 degrees, tread region 520 represents 30 degrees, and tread region 620 represents 45 degrees.

Each tread pattern was tested for hydroplaning performance using a test procedure that can be generally described as follows: Eight tires were constructed. At least two tires each were constructed having tread regions as schematically represented in one of FIGS. 3A through 3D such that a total of four pairs—each bearing one of these four patterns was provided.

The front wheels of a test vehicle having front wheel drive were then fitted with two tires—each having the same tread pattern. The test vehicle was driven through water having a depth of 8 mm (0.315 inch) on an asphalt track at a speed of 50 kph (about 31 miles/hour). Preferably, this speed was maintained by using e.g., cruise control on the vehicle. Once the vehicle reached the validation area, the driver accelerated the vehicle as quickly as possible for 30-50 m (about 98-164 feet) (this distance is fixed as desired) to see if 10% slip could be generated between the speed of the drive wheels and the GPS speed of the vehicle. If 10% slip was achieved, this same test run was repeated three more times. If 10% slip was not achieved, then the test run was performed by adding 5 kph (3.107 miles/hour) to the initial vehicle speed. This step was then repeated until 10% slip was achieved. Once the 10% slip was achieved, then another three runs at the same conditions as previously described was conducted. Usually, five total runs were made with the first and last runs being used for reference only. Data is then acquired from these runs and a statistically relevant calculation of the speed at which hydroplaning occurs, which corresponds to the vehicle speed at which 10% slip happens, is constructed. Using this data, a performance measurement result was created.

Accordingly, Table 1 summarizes the results of testing for hydroplaning.

TABLE 1

| | | | | |
|---|---|---|---|---|
| Tread Region | 320 | 420 | 520 | 620 |
| Hydroplaning | 100 | 97 | 96 | 99 |

Pattern 320 is assigned a value of 100 since groove 310 is parallel to the circumferential direction and theoretically represents the best performance for this pattern. As demonstrated by the results, improved wet traction performance was achieved at an angle α of as high as 45 degrees from the circumferential direction. The result is substantial because conventionally it would be expected that wet performance would decrease as the transverse groove (410, 510 and 610) is oriented further away from a perfectly circumferential orientation as represented by groove 310.

Each tread pattern was also tested for snow traction performance using a test procedure that can be generally described as follows: An analytical measurement of the tire mu-slip curve is conducted under driving torque provided by a testing machine. In general, the mu-slip curve is represented by the coefficient of friction μ (mu) between the wheel and the running surface on a vertical axis and the slip ratio on the horizontal axis. The testing protocol involves the average μ (mu) measured during a 1.5 second interval after 2 mph (3.219 kilometers/hour) DIV (40% slip). The track on which testing was conducted is a soft snow track with a CTI penetrometer value of around 85.

Table 2 summarizes the results of testing for snow traction.

TABLE 2

| | | | | |
|---|---|---|---|---|
| Tread Region | 320 | 420 | 520 | 620 |
| Snow Traction | 100 | 108 | 163 | 181 |

Pattern 320 was assigned a value of 100 for reference. As demonstrated by the date in Table 2, the snow traction performance dramatically increased as the angle of the transverse groove increased from the circumferential direction.

Accordingly, the transversely-oriented groove as described in the present invention provides a tire having improved wet and snow traction without unacceptable tradeoffs in performance between the two. In addition, as compared with conventional designs, the use of circumferentially-oriented grooves to provide improved wet traction (at the expense of snow traction) is avoided.

### Hydroplaning Analysis

Given these promising results, the inventors of the present invention researched why these designs showed such good hydroplaning results. Using commercially available ABAQUS 6.10 finite element analysis software, a simplified tire tread pattern and underlying ply structure were modeled. While the actual tire tread is a 3D curved beam, the 1st order crown structural stiffness can be modeled by considering the structure as a simply supported beam subjected to a uniform pressure. In this problem, the pressure represents the hydrodynamic pressure, the beam is the crown of the tire (consisting of tread, subtread, and all ply reinforcement), and the supports are the shoulder.

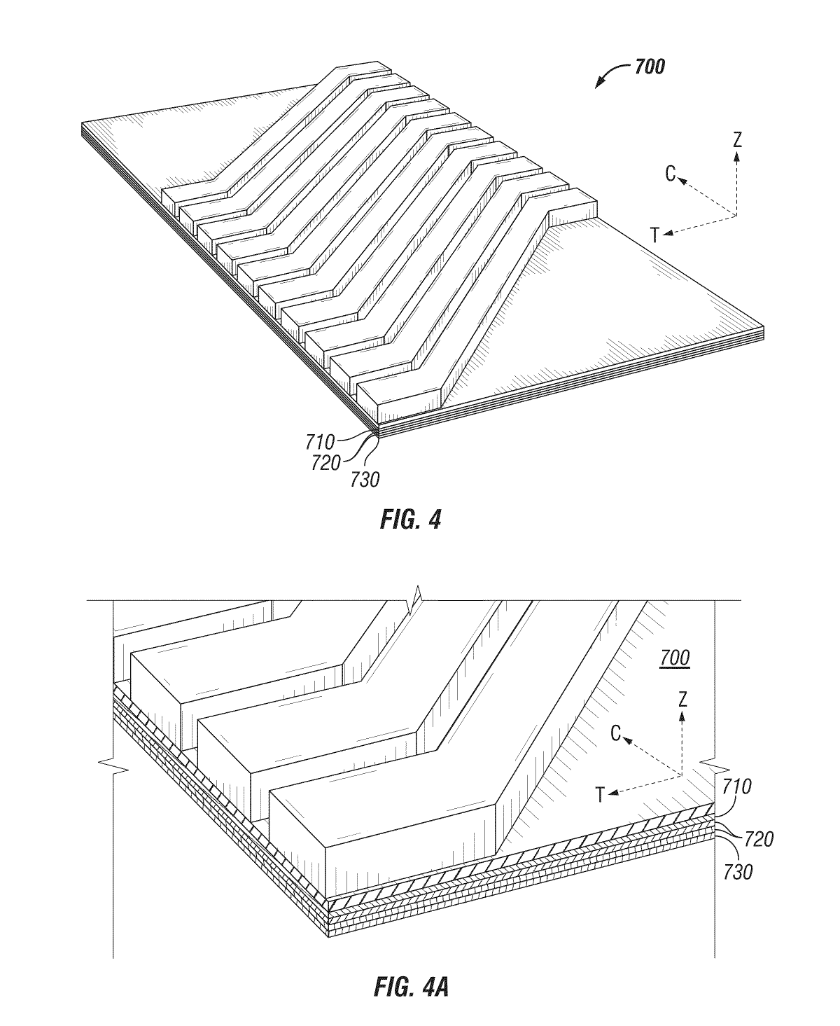

The model is shown in FIG. 4. The structure has a tread 700, sub tread 710, two belts or cross plies 720, and a radial carcass ply 730. It is simply supported on the left (T=0) and right (T=180 mm (7.087 inches)) sides, and is subjected to a 1 bar pressure in the Z direction. The crown width is equivalent to that generally found on a 205/55R16 tire.

The image in FIG. 4A shows a more refined view of the structure, with different materials shown in different cross hatching. The ply structure can be seen. The ply structural stiffness was appropriately represented using isotropic and orthotropic material definitions familiar to those skilled in the art of using FEA software such as ABAQUS. For the two steel plys: Direction 1=cable direction=+25 degrees (clockwise) from the C (circumferential) direction for ply1, −25 degrees (counterclockwise) for ply2; Direction 2=in plane of ply, right hand rule; and Direction 3=derived from directions 1 and 2 using the right hand rule. Young's Modulus is E1=20000 MPa, E2=E3=30 MPa, poisson's ratio is υ₁₂=υ₁₃=υ₂₃=0.5, G12=G23=5 MPa, G13=100 MPa. For the carcass ply: Direction 1=90 deg (Y direction); E1=1000 MPa, E2=E3=20 MPa, υ₁₂=υ₁₃=υ₂₃=0.5, G12=G23=4 MPa, and G13=7 MPa. At the same time the tread rubber is isotropic with E=5 MPa and the undertread rubber is isotropic with E=20 MPa.

An example of the deformed geometry is shown in FIG. 5. Various cross hatching represent the differing amounts of deflection in the Z direction. For this study, the absolute Z deflection was arbitrary as the deflection shown is actually in the opposite direction than the tread would actually experience in use. The important parameter was relative deflection between different solutions as the deflection shown would be equal and opposite to that experienced when used on an actual tire. The design goal was to minimize Z deflection by changing the tread pattern.

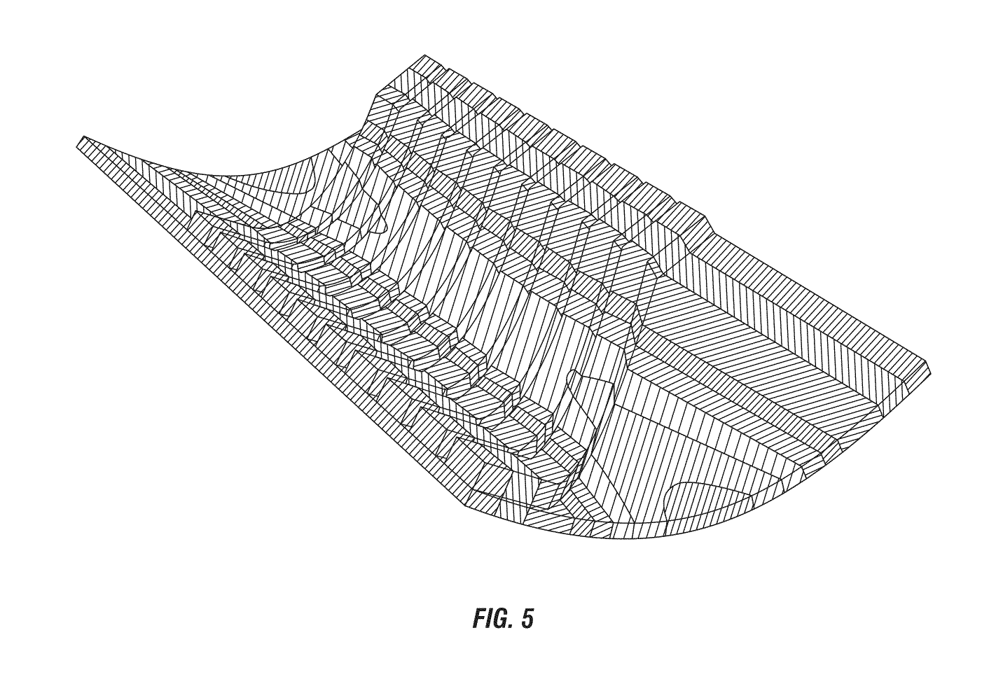

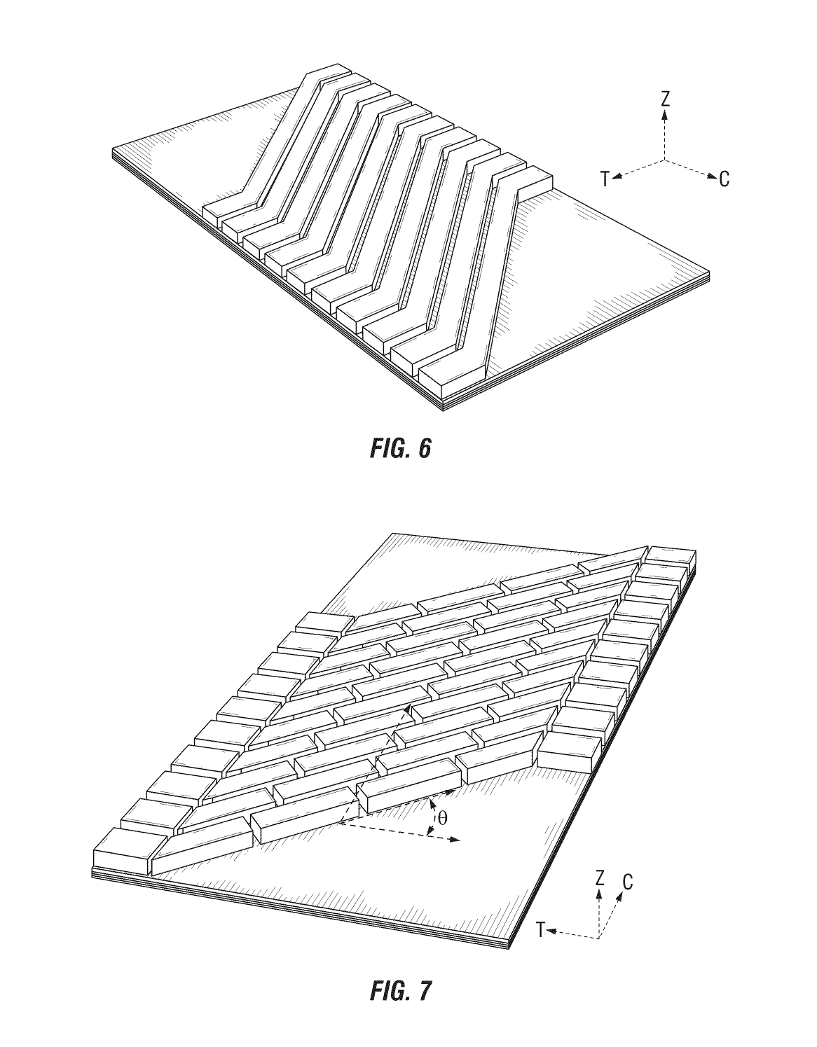

Several different tread pattern solutions were analyzed. FIG. 6 depicts an example of a tread pattern that has diagonal and continuous ribs all the way across the crown, similarly to what was tested above for snow and hydroplaning performances.

On the other hand, FIG. 7 shows an example of the same pattern, but with cuts or grooves across the diagonal rib. The angle of inclination of the ribs is denoted as θ, referenced to the lateral or transverse direction T.

Table 3 below summarizes the result of this PEA study. Tread depth=9 mm (0.3543 inch) for all cases, rib X or C distance=20 mm (0.7874 inches), and diagonal groove X or C width=6.5 mm (0.2559 inches).

TABLE 3

| | | Number of lateral | Normalized |
|---|---|---|---|
| Model | Rib Angle θ | cuts in rib | Bending Stiffness |
| A | 45 | 5 | 100% |
| B | 45 | 0 | 137% |
| C | 0 | 0 | 241% |

These results show that eliminating all cuts across the 45 deg. diagonal ribs increases structural crown bending stiffness by 37%. If the ribs are oriented at a 0 deg angle—going straight across the crown in the lateral direction—stiffness is maximized at 241%, compared to the reference. Thus, we see that eliminating rib discontinuities increases stiffness, which is good for hydroplaning. We also see that increasing the rib inclination angle also improves structural stiffness.

### Carved Tire Hydroplaning Results

The other parameter to be considered for hydroplaning is water evacuation efficiency of the tread design. This was studied with carved tires. The hydroplaning speed was determined using the above described testing protocol for determining hydroplaning speed except that an approach speed of 65 kph (about 40 miles/hour) was used and the length of the testing area was 85 m (278.9 feet) with only actually 20 m (65.62 feet) of the run being measured.

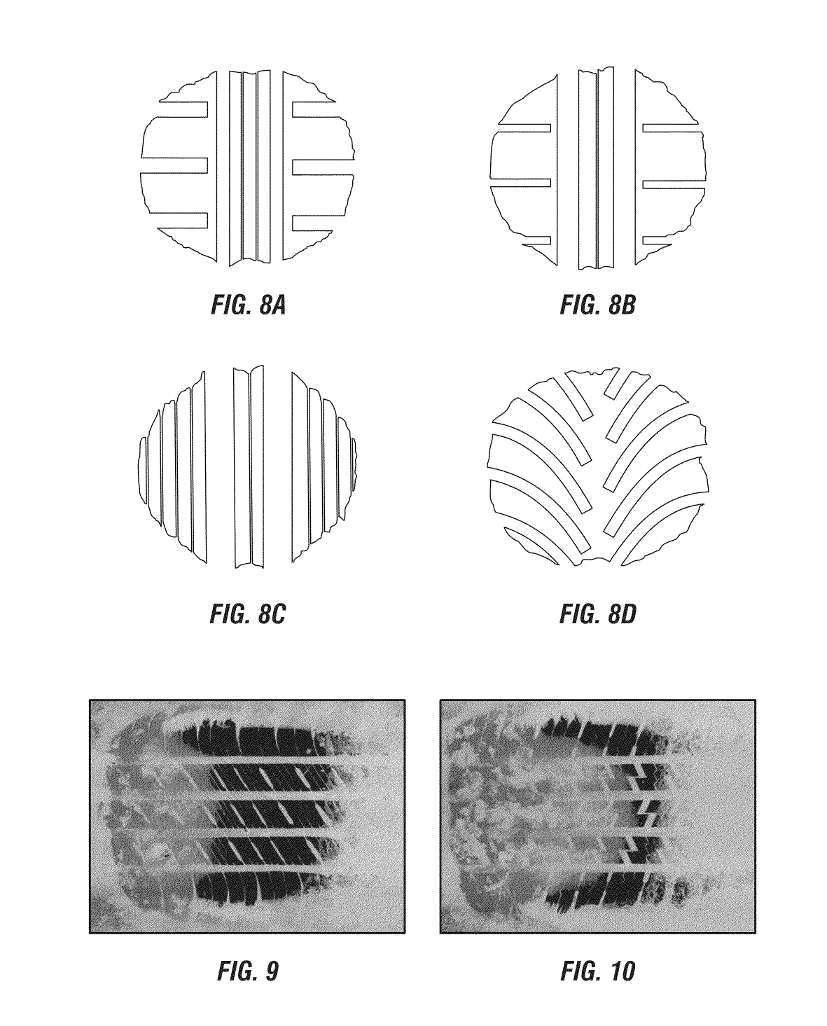

Using this protocol, tires having tread patterns of different void volume ratios were measured. The lateral void volume and the circumferential void volume were independently varied, while total void volume was held constant. Load was 625 DaN and internal air pressure was 2.3 bars for each tire which was a 195/65R15 sized tire. The four tread patterns for tires A thru D via their associated footprints are shown in FIGS. 8A thru 8D respectively. The respective percentages for lateral void versus total void, circumferential void versus total void, and hydroplaning performance is shown below in Table 4.

TABLE 4

| Tire | Hydroplaning Perf. | Lateral Void | Circumferential Void |
|---|---|---|---|
| A | −2.3% | 50% | 50% |
| B | Reference | 25% | 50% |
| C | +2.9% | 0 | 100% |
| D | +4.1% | Diagonal and | N/A |
| | | Directional | |

Results from tires A, B, and C show that continuous, unbroken circumferential void volume is more efficient than a combination of lateral and circumferential. In fact, higher lateral void volume gives less efficiency. Tire D result shows that a diagonal, directional pattern with no rib discontinuities is the most efficient.

The images in FIGS. 9 and 10 are footprints of two different P215/70R15 sized tires running through water at 55 mph (about 88 kilometers/hour). The tire in FIG. 10 has a higher lateral void, with an open block structure. The tire in FIG. 9 is closer to a straight ribbed tire. The straight ribbed tire has less water turbulence and a 3× higher contact area. This is consistent with the results reported above also.

As discussed previously, a directional tire has advantages in terms of hydroplaning performance, yet has other disadvantages. A directional tire can't be cross-rotated as can a non-directional tire. There is also a preferred mounting direction, which adds to logistics difficulties for mounting garages and OE manufacturers. On the other hand, a non-directional tire that is best in hydroplaning performance has continuous circumferential ribs. Yet, for snow traction, lateral features are important. But, lateral features and circumferential features used together lessen hydroplaning performance. The use of transverse grooves that extend across the tread and that have no fluid communication between them breaks this compromise.

This design breaks compromises for three reasons. First, it has high bending stiffness, as previously explained. This is good for hydroplaning performance. Second, it behaves essentially like a straight ribbed tire, like Tire C in the carved tire study, yet creates lateral features because of the diagonal pattern. It can have excellent snow traction without deteriorating hydroplaning performance. Third, it has a high contact surface ratio, which is good for wear and dry traction. Because the ribs are continuous, the actual rubber volume is quite high. The tread pattern efficiency is improved because circumferential and lateral functions (hydroplaning and snow) are accomplished simultaneously.

### Solution for Pull Under Torque

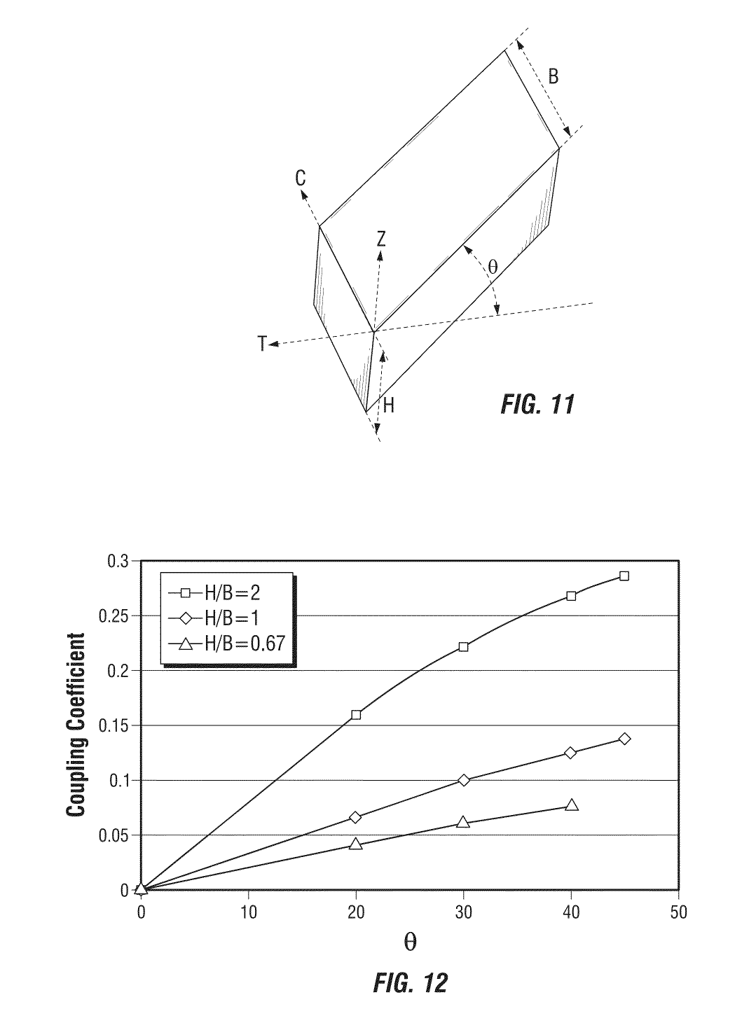

Unbroken diagonal tread patterns have a disadvantage as they are proned to having pull under torque. Diagonal features create a coupling between F_{C} (torque) and F_{T} (lateral or transverse force). Thus, it is necessary to overcome this problem by appropriately analyzing and designing the tread pattern. The degree of coupling is strongly a function of the ratio of the tread height divided by the width of the rib in the circumferential direction (see FIG. 11). It is also a strong function of the inclination angle θ of the rib. These effects are shown in the graph depicted in FIG. 12, which was generated using Abaqus FEA.

The FEA shows that F_{T} F_{C} coupling increases with θ; yet, it is desirable to have a θ=45 degrees for optimum snow/hydroplaning performance. Thus, it is necessary choose an H/B ratio around 0.67 in order to reduce the coupling from 0.28 to around 0.075. 7.5% is a value acceptable for replacement market tires. Even lower values such as 3% may be required for some original equipment customers.

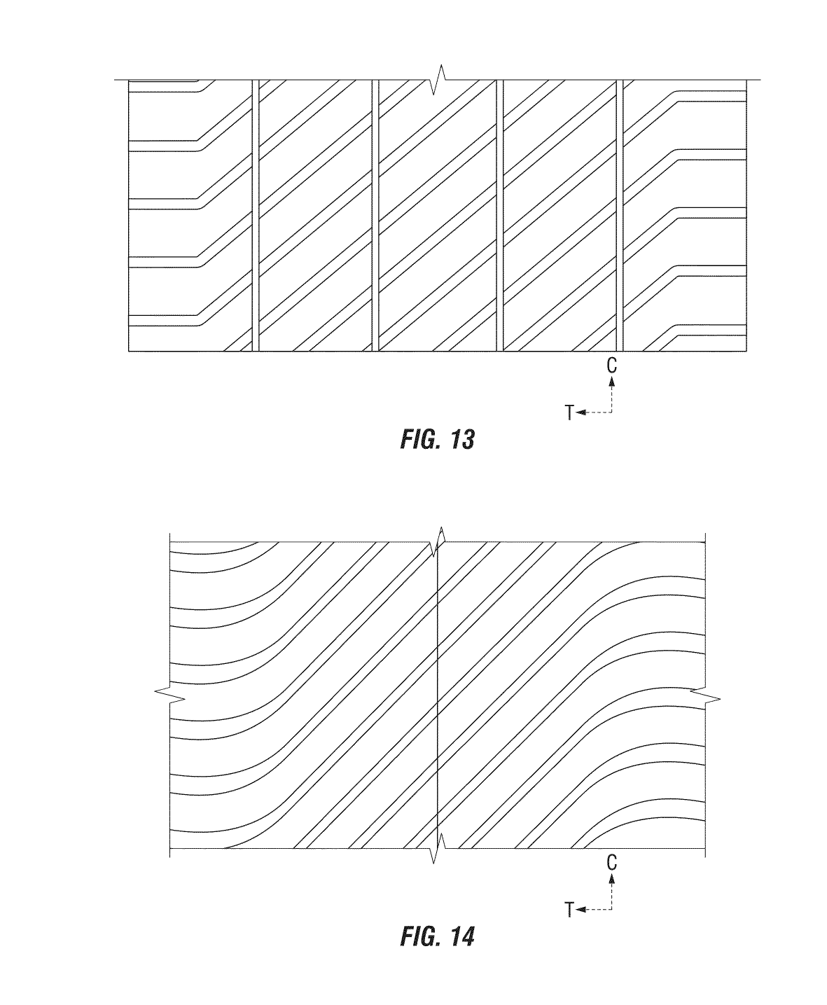

To combine these design elements and verify the direction indicated by the FEA, two additional tires were carved. These are pictured in FIGS. 13 and 14. Carved in the dimension of 205/55R16, tires E and F are identical except that tire E (shown in FIG. 13) has circumferential grooves of 2 mm (0.07874 inch) width, while tire F (shown in FIG. 14) has only continuous diagonal ribs at a 45 degree inclination angle. CSR (contact surface ratio) was 0.73 for tire F and was 0.77 for tire E. Both had a tread depth of 8 mm (0.315 inch),

From conventional wisdom of those skilled in the art, decreasing CSR—especially by adding circumferential features—should improve hydroplaning performance. Tires E and F were tested in hydroplaning. Tire F had a 3.2% advantage over Tire E (average of 4 runs/tire). Additionally Tire F was equivalent to a current production all season tire having a CSR=0.71 and a tread depth of 9 mm (0.3543 inch).

This result substantiates that there is a great deal of efficiency of the diagonal tread pattern for hydroplaning performance and that there is a non-intuitive advantage of suppressing circumferential features for this design, related to tread bending stiffness, and potentially related to reduction in water turbulence also.

Consequently, the best practice for this tread pattern concept is that of Tire F. This design combines the efficiency of the diagonal pattern in the center of the contact area with wider, more lateral grooves in the shoulders to enable better lateral evacuation of water in the shoulder region. In addition, there are no circumferential voids and the ribs are continuous. This design is quite similar to that shown and described in FIG. 1 except that the H/B dimensions were optimized for reducing pull under torque. For Tire F, the H/B ratio was 0.50. This tire was then tested for pull under torque using a machine test procedure. The loading condition for this 205/55R16 sized tire was: 2.4 bar, 460 kg of load, and a speed of 3.5 kph. This loading value represents 75% of the maximum load of a front wheel drive car using this sized tire. The test machine then measured lateral force for the free rolling condition at a slip angle of zero degrees. Then, a driving torque was added. A ramp signature was used, whereby torque was linearly increased from zero to 400 N*m over a one minute time period. The machine again measured the lateral force and then data processing calculated the relationship between circumferential and lateral forces.

Also, the hydroplaning performance was tested using the modified testing protocol described above. The test results are as follows. The hydroplaning performance was determined to be 1.5% better for the new tire that only had 7.6 mm (0.2992 inch) of tread depth and a CSR of 77% than a MXV4 Primacy tire, which lacks slanted grooves, has a CSR of 70% and has a 9 mm (0.3543 inch) tread depth. Also, the pull under torque coefficient for the improved tire with an appropriate H/B ratio was 2.9% when subjected to a driving torque.

These results show that changing the H/B ratio unexpectedly decreases the pull under torque for such designs without altering the hydroplaning performance significantly. While snow traction was not retested, the inventors believe that the impact on snow traction is low and given the large gain proven possible for transversely oriented s-shaped grooves such as 50%, any loss created by modifying the H/B ratio would not be material to the overall performance of the tire and the snow and wet traction compromises have been effectively broken. Also, the present invention allows the improvement of hydroplaning performance while maintaining good pull under torque characteristics while enabling the use of lower tread depth and a higher contact surface area. This solution also provides a critical result in that tires with such improvements in wet and snow traction would also be marketable to original equipment manufacturers, which have lower tolerance for the amount of pull under torque such as 3% that tires exert on a vehicle when it accelerates.

In yet another embodiment contemplated by the inventors, Tire F would be modified such that it would have a CSR that equals 0.76, 1.5 mm (0.05906 inch)×1.5 mm (0.05906 inch) chamfers would be found around the perimeter of the grooves (see published patent application no. WO2011062595 (A1) that is commonly owned by the assignee of the present invention for a further description of this technique), a groove inclination angle of 45 degrees and a tread depth that equals 7.5 mm (0.2953 inch). In other words, a tire having continuous diagonal ribs, mated with specific requirements for H/B to fix pull under torque, a high CSR, a 45 degree rib inclination, and chamfers can be used along with the appropriate tread rubber, to yield excellent dry, wet, snow, and wear performances.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. For example, while the optimization of H/B dimensions has been applied to s-shaped grooves in particular, it is contemplated that the present design could also be applied to any design where slanted grooves are used such as those described in published patent application no. WO 2012002947 (A1). Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A tire for high speed, on-road use, the tire defining transverse and circumferential directions and having a shoulder positioned along each side of the tire, the tire comprising:
a tread region positioned between the shoulders of the tire, the tread region further comprising a plurality of transversely-oriented grooves extending between the shoulders of the tire and across the tread region, wherein said grooves have a portion that is slanted with respect to the circumferential direction and have a width and define ribs that have H and B dimensions associated therewith, wherein the ratio of H/B has a value of 1 or less.

2. A tire for high speed, on road use, as in claim 1, further comprising a central portion positioned at an overall angle in the range of about 30 degrees to about 50 degrees from the circumferential direction and wherein said plurality of transversely-oriented grooves are not connected by a groove or other feature that would provide fluid communication between the transversely-oriented grooves.

3. A tire for high speed, on-road use as in claim 2, wherein said central portion has a groove width in the range of about 3 mm (about 0.1181 inch) to about 5 mm (about 0.1969 inch).

4. A tire for high speed, on-road use, as in claim 2, further comprising a pair of transition portions, each said transition portion positioned in fluid communication with said central portion and connected to ends of said central portion.

5. A tire for high speed, on-road use as in claim 4, wherein the groove width of said transition portions increases in a direction moving away from said central portion towards the shoulder of the tire.

6. A tire for high speed, on-road use, as in claim 4, further comprising a pair of shoulder portions, each said shoulder portion positioned in fluid communication with said central and transition portions, said shoulder portion connected to outer ends of said transition portions and located at least partly along the shoulders of the tire.

7. A tire for high speed, on-road use as in claim 6, wherein said shoulder portions are oriented at an overall angle in the range of about 75 degrees to about 90 degrees from the circumferential direction.

8. A tire for high speed, on-road use as in claim 7, wherein said shoulder portions are oriented at an overall angle in the range of about 80 degrees to about 90 degrees from the circumferential direction.

9. A tire for high speed, on-road use as in claim 6, wherein the groove width of said shoulder portions increases in a direction moving away from said central portion towards the shoulder of the tire.

10. A tire for high speed, on-road use as in claim 6, further comprising a plurality of sipes extending between said plurality of transversely-oriented grooves.

11. A tire for high speed, on-road use as in claim 10, wherein said sipes include a cavity for receipt of water or snow during operation of the tire.

12. A tire for high speed, on-road use as in claim 1, wherein the tread has a contact surface ratio that is at least 0.7 or higher.

13. A tire for high speed, on-road use, as in claim 6, wherein said central portion is linear in shape.

14. A tire for high speed, on-road use as in claim 1, wherein each of said plurality of transversely-oriented grooves have a generally s-shaped appearance and wherein the tread further comprises one or more sipes that run parallel to a direction in which a portion of one of the grooves extends.

15. A tire for high speed, on-road use as in claim 1, wherein the tread comprises an edge along each groove has at least a 1 mm (0.03937 inch)×1 mm (0.03937 inch) chamfer thereon.
